(19) United States
(12) Patent Application Publication
(10) Pub. No.: US 2014/0070055 A1
(43) Pub. Date: Mar. 13, 2014

(54) CONTROL SAIL FOR A KITE

(71) Applicant: Peter Stiewe, Neustadt (DE)

(72) Inventor: Peter Stiewe, Neustadt (DE)

(21) Appl. No.: 14/025,306

(22) Filed: Sep. 12, 2013

(30) Foreign Application Priority Data
Sep. 13, 2012 (DE) DE102012018187.6

(51) Int. Cl. B64C 31/06

(52) U.S. Cl. CPC B64C 31/06
USPC 244/155 A

(57) ABSTRACT

A control sail for a kite has an airfoil with a leading edge and a trailing edge, and a tube system comprising a front tube which extends along the leading edge and at least one transverse tube which extends between the leading edge and the trailing edge. The front tube is situated in a freely movable manner within a chamber which extends along the leading edge of the airfoil whereby an aerodynamically advantageous profile at the leading edge may be continuously maintained, even when the angle of attack of the control sail changes. The invention further relates to a kite having a control sail according to the invention, with control lines connected to the control sail.

### CROSS REFERENCE TO RELATED APPLICATIONS

This application claims priority of German Patent Application Serial No. DE 10 2012 018 187.6, filed on Sep. 13, 2012.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all rights whatsoever.

### BACKGROUND OF THE INVENTION

1. Field of the Invention

The present invention relates to a control sail for a kite, having an airfoil and a tube system, and a kite having such a control sail.

2. Description of Related Art

Kites having these types of control sails, also referred to as tube kites, are known from the prior art. DE 102 13 403 A1 and DE 10 2009 009 305 A1 each disclose a tube kite having a control sail which has an airfoil with a leading edge and a trailing edge, between which the airfoil extends. In addition, the cited publications disclose a tube system comprising a front tube which extends along the leading edge of the airfoil, and transverse tubes which extend between the leading edge and the trailing edge. A chamber in which the front tube is situated is provided which extends along the leading edge, preferably by turning down the airfoil material. According to DE 102 61 056 A1, in addition to the front tube a further longitudinal tube is provided in the chamber. The front tube and the transverse tube are generally inflatable bodies, and are permanently connected to the airfoil, or more precisely, fixed in the chamber, for example by sewing or gluing.

As a result of fixing the front tube inside the chamber, it is not possible, depending on the angle of attack of the control sail, to orient the front tube within the chamber in such a way that a uniform, aerodynamically advantageous profile is formed at the leading edge, regardless of the angle of attack. Thus, in the control sails from the prior art this frequently results in a lower sail which flaps and is not stable, and which is generally formed by the bottom side of the chamber which extends from the leading edge toward the trailing edge.

### BRIEF SUMMARY OF THE INVENTION

The object of the present invention, therefore, is to provide a control sail and a kite having such a control sail, in which an essentially uniform, aerodynamically advantageous profile is formed at the leading edge, regardless of the angle of attack of the control sail. This object is achieved by the subject matter of the independent claims. The dependent claims refine the central concept of the invention in a particularly advantageous manner. According to a first aspect, the invention relates to a control sail for a kite which has an airfoil and a tube system. The airfoil in turn has a leading edge and a trailing edge, between which the airfoil extends. The tube system has a front tube which extends along the leading edge. In addition, the tube system has at least one transverse tube which extends between the leading edge and the trailing edge. The front tube is situated in a freely movable manner within a chamber which extends along the leading edge of the airfoil. In this regard, the front tube is preferably situated within the chamber so that it is freely movable at least in a direction transverse to the longitudinal extent of the chamber, and in particular at least in a direction that is essentially parallel to the direction of flow incident to the leading edge.

As a result of the freely movable arrangement of the front tube within the chamber, i.e., in particular due to the fact that at least the front tube is not permanently connected to the airfoil of the control sail, the chamber may be easily tensioned over the front tube. On account of the tension which is thus built up between the front tube and the chamber, it is preferably made possible for the upper sail and the lower sail of the chamber to form an aerodynamically advantageous profile, in particular an aerodynamic droplet shape. Since the front tube is thus situated so that it is freely movable relative to the chamber (more precisely, relative to the inner wall of the chamber), the aerodynamically advantageous (droplet) profile at the leading edge is continuously maintained, even when the angle of attack of the control sail changes, so that the chamber maintains its advantageous profile as well as its dimensional stability, even for different angles of incidence. In this way, the chamber may maintain a stable design, regardless of the angle of attack and the angle of incidence, thus in particular avoiding an unstable, flapping lower sail. In turn, the turbulences which form in the suction area of the front tube, i.e., on the bottom side of the chamber, may thus be reduced, resulting in a reduction of the flow resistance and increased efficiency of the kite. This in turn results in an increased travel speed, an increased flight altitude and flight duration during jumps, an improved upward motion when tacking into the wind, a larger wind range, and an increased throttling capability (depowering). It is thus advantageously made possible that the chamber for accommodating the front tube forms an aerodynamic droplet-shaped profile which tapers from the leading edge toward the trailing edge, at least when the airfoil is stretched out. Due to the preferred tensioning of the two bodies, i.e. the chamber and the front tube, increased dimensional stability of the kite overall may be achieved by use of the control sail according to the invention. In addition, due to the front tube (or also the transverse tube) being situated in a freely movable manner in the chamber, it is possible to easily replace the front tube if necessary.

The chamber for accommodating the front tube is preferably integrally formed with the airfoil, and is provided, for example, by turning down the airfoil material along the leading edge, the area of the chamber extending on the bottom side from the leading edge toward the trailing edge also being referred to as the lower sail. In principle, it is also conceivable and particularly preferred that the chamber is provided separately and mounted or affixed (glued, sewn, etc.) along the leading edge. Compared to a chamber which is integrally formed with the airfoil, this has the advantage that a material having preferred chamber properties (sufficient dimensional stability, for example) may be used which is less costly than the airfoil material.

The at least one or more transverse tubes is/are either detachably or nondetachably connected to the airfoil. A nondetachable connection may be provided, for example, by sewing or gluing. A preferred detachable mounting of the transverse tube may be provided, for example, by fastening via loops, straps, Velcro fasteners, snap fasteners, or the like in order to provide the transverse tube at appropriate areas and in an appropriate orientation on the airfoil. Similarly as for the arrangement of the front tube, the at least one transverse tube may also be accommodated in a freely movable manner in a chamber which preferably extends between the leading edge and the trailing edge. According to one embodiment, the chamber for accommodating the front tube and the chamber(s) for accommodating the transverse tube(s) may be connected to one another, or may also be present separate from one another. The chambers, viewed in their longitudinal extent, may have a closed cross section at least over a portion, or over all of their length.

Furthermore, the chambers may have at least one closable opening or may have a closable design overall in order to be exchangeably inserted into the chambers through the opening in the front tube or the transverse tube. These openings are preferably provided at at least one or also at both ends of the chamber, viewed in the longitudinal extent of the chamber in question, so that the front tube or the transverse tube(s) may be easily pushed in at corresponding ends of the chamber and selectively replaced.

The chambers may be formed from or enclosed by the same material as the airfoil. It is also conceivable that the chambers are formed, at least in part, from a mesh-like or net-like material, or that the material has a corresponding mesh-like or net-like structure, wherein for accommodating the front tube, the chamber is preferably provided with a corresponding mesh-like or net-like material only on its bottom side, i.e., the side which forms the lower sail.

An aerodynamic profile of the control sail preferably results (only) by tensioning the airfoil over the front tube and/or the at least one transverse tube. According to one particularly preferred embodiment, the front tube and/or the at least one transverse tube in each case is/are connected at at least one or both of its/their opposite ends, viewed in the longitudinal extent, by means of a tensioning device for tensioning the airfoil on the front tube and/or the at least one transverse tube. The tensioning device is then preferably connected to the airfoil. A simple tensioning mechanism may thus be provided which allows rapid and easy replacement of the front tube or transverse tube.

In particular when the chambers for accommodating the front tube and the at least one transverse tube are connected to one another, the front tube and the at least one transverse tube may be joined together, preferably integrally joined together, so that preferably the entire tube system has an integral design. Alternatively, it is conceivable for the front tube and the at least one transverse tube to be provided separately, and thus situated separately from the respective other tubes within the particular chamber, which may be connected to the other chambers or also provided separate from same.

The front tube and/or the at least one transverse tube may have a dimensionally stable body or be designed as a dimensionally stable body, and preferably has/have an inflatable body or is/are formed as a foam body. However, it is also possible for the front tube and/or transverse tube to have some other known body or to be made of some other known material. Within the scope of the invention, “dimensionally stable” is understood to mean that the tube in question has a predefined shape (straight or curved, for example) which, in conjunction with the control sail (for example, for the front tube situated in the chamber), the tube essentially conveys to the control sail (in particular the chamber), and thus stretches out the control sail in a defined manner.

According to another aspect, the invention relates to a kite having a control sail according to the invention as well as control lines and preferably safety lines, which in each case are connected to the control sail in a known manner.

Further advantages, embodiments, and features are described below by means of the exemplary embodiments, with reference to the accompanying figures of the drawing.

### BRIEF DESCRIPTION OF THE SEVERAL VIEWS OF THE DRAWINGS

FIG. 1 shows a perspective view of a kite having a control sail according to the invention; and

FIG. 2 shows a cross section of a portion of the control sail according to FIG. 1, viewed in the direction of longitudinal extent of the chamber.

### DETAILED DESCRIPTION OF THE INVENTION

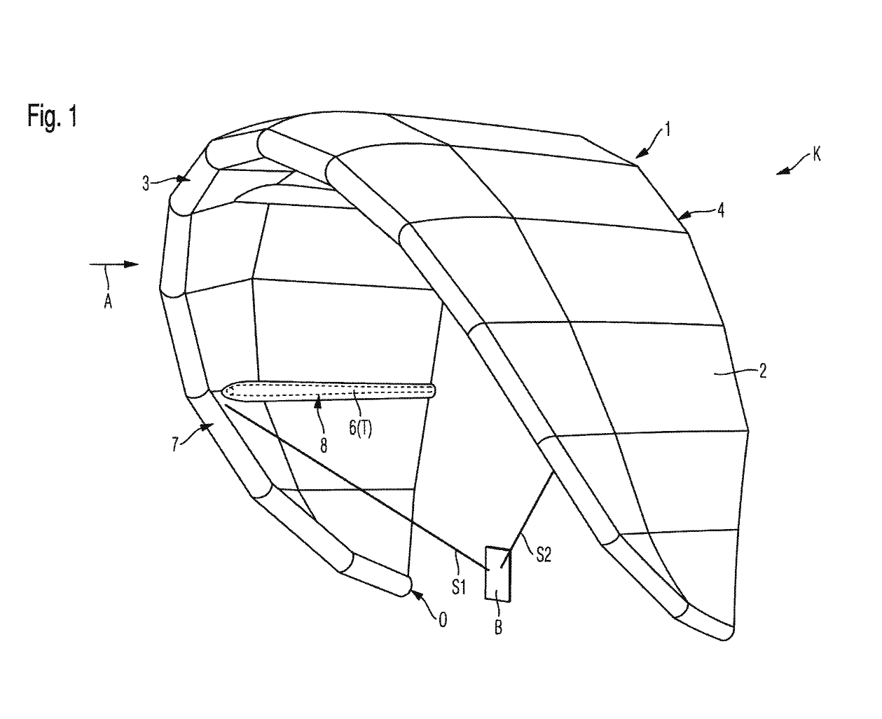

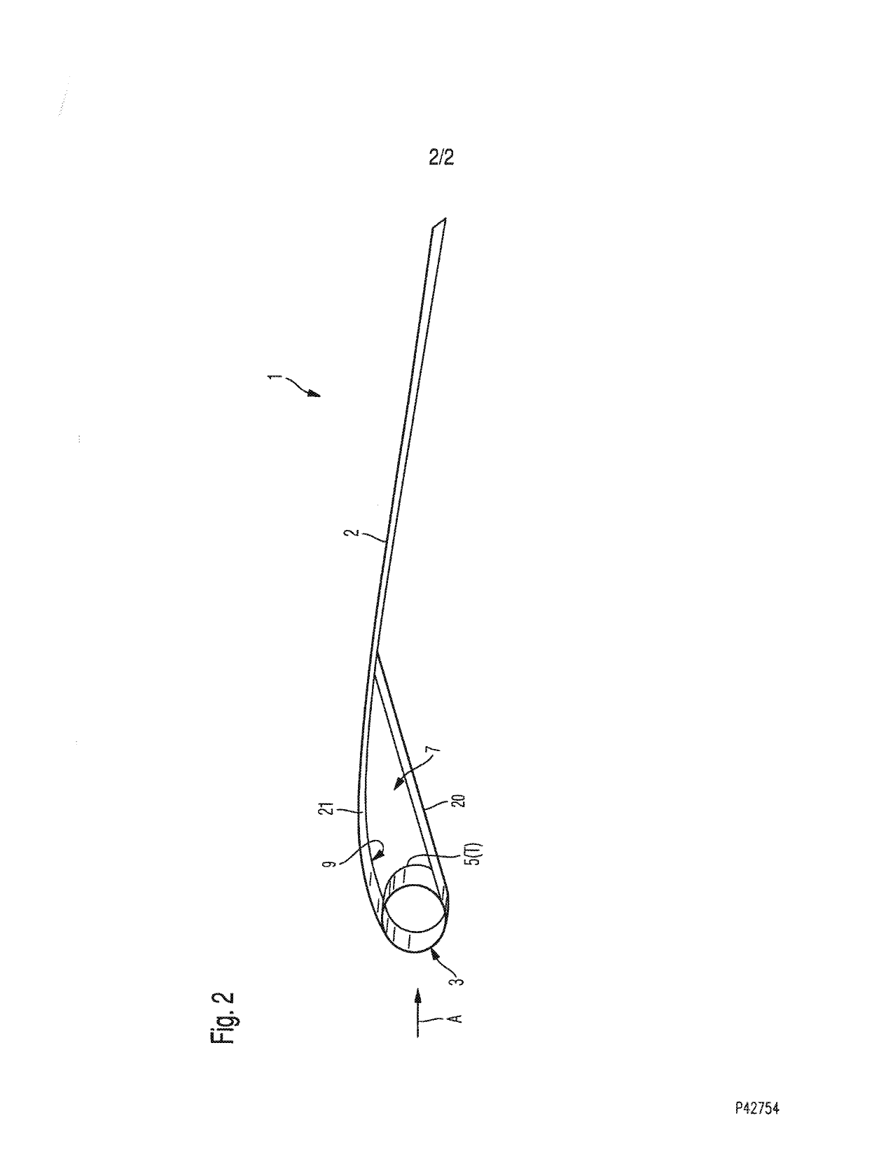

FIGS. 1 and 2 show a control sail 1 and a kite K having a control sail 1 according to one exemplary embodiment of the invention. The control sail 1 has an airfoil 2 which is made of a suitable material, preferably a ripstop fabric such as polyester ripstop, for example. The airfoil 2 has a leading edge 3 which preferably extends along the entire front edge of the airfoil 2. In addition, the airfoil 2 has a trailing edge 4 which extends along the entire rear edge of the airfoil 2. The airfoil 2 extends between the leading edge 3 and the trailing edge 4.

Furthermore, the control sail 1 has a tube system T. The tube system T has a front tube 5 which extends along the leading edge 3, preferably along the entire leading edge 3. In addition, the tube system T has at least one transverse tube 6 (in FIG. 1, four transverse tubes 6, one of which is schematically illustrated) which extends between the leading edge 3 and the trailing edge 4, preferably essentially over the entire extent or length between the leading edge 3 and the trailing edge 4, and at an angle, preferably essentially perpendicularly, with respect to the front tube 5.

An aerodynamic profile of the control sail 1 preferably results by tensioning the airfoil 2 over the front tube 5 and/or the at least one transverse tube 6, i.e., by tensioning the airfoil 2 over the tube system T.

The front tube 5 as well as the at least one transverse tube 6 preferably have a dimensionally stable body or are designed as dimensionally stable bodies. For this purpose, the front tube 5 and the transverse tube 6 are particularly preferably provided as inflatable bodies. However, it is also conceivable for the front tube 5 and the transverse tube 6 to be designed as (porous) foam bodies. The tube system T advantageously forms an essentially dimensionally stable floating body which supports the control sail in the water at the water surface. The front tube 5 and the at least one transverse tube 6 may either be provided separately or connected to one another, preferably integrally formed.

A chamber 7 in which the front tube 5 is situated extends along the leading edge 3 of the airfoil 2 over part, or preferably all, of the leading edge 3. Chamber 7 may also be referred to as the “font chamber” or “front tube chamber” due to its function of receiving the front tube 5 movably diposed therein. The chamber 7 as well as the front tube 5 extend along at least part, but preferably along all, of the leading edge 3. The chamber 7 may be integrally formed with the airfoil 2. For this purpose, the airfoil 2 or the airfoil material is turned down along the leading edge 3, i.e., preferably turned downwardly by 180°, and with the end which then faces the trailing edge 4 is in turn fastened to the bottom of the airfoil 2 so that the resulting cavity forms the chamber 7. The area extending from the leading edge 3 beneath the airfoil 2 to the rear toward the trailing edge 4 is also referred to as the lower sail 20, and the upper area of the airfoil 2 is referred to as the upper sail 21. Alternatively, the chamber 7 (likewise having a lower sail 20 and an upper sail 21) may also be provided separately and be fastened to the airfoil 2 along the leading edge 3. This is advantageous compared to an integral design of the chamber 7 with the airfoil 2, in particular due to the fact that a less costly material (Dacron®, for example) having preferred chamber properties (for example, increased dimensional stability for producing a curvature of the control sail 1 via the chamber 7 and the front tube 5) may then be provided for the chamber 7.

For accommodating the front tube 5, the chamber 7 forms an aerodynamic, preferably droplet-shaped, profile, at least when the airfoil 2 is stretched out, which, as is apparent in FIG. 2, tapers from the leading edge 3 toward the trailing edge 4.

In order to provide the chamber 7, i.e., the aerodynamically advantageous, preferably droplet-shaped, profile, in a stable and non-flapping manner, in particular regardless of an angle of attack of the control sail, the front tube 5 is not permanently connected to the airfoil 2, as in the prior art; instead, according to the invention the front tube is situated within the chamber 7 in a freely movable manner. Since the front tube 5 is thus optimally positioned within the chamber 7 regardless of the angle of attack, this results in an aerodynamically advantageous profile at the leading edge 3, in particular when the chamber is or becomes tensioned over the front tube 5 (and the transverse tube 6) at the leading edge 3.

Within the scope of the invention, “free movability” of the front tube 5 is understood in particular to mean that the front tube 5 is situated within the chamber 7 at least in a direction transverse to the longitudinal extent of the chamber 7, i.e., in the plane of the drawing in FIG. 2, for example, in a freely movable manner (i.e., not connected to the airfoil 2 or the chamber wall 9), so that the chamber 7 may be easily tensioned over the front tube 5. Due to the tensioning which is thus built up between the front tube 5 and the chamber 7, it is preferably made possible for the chamber 7, more precisely, the upper sail 21 and lower sail 20 thereof, to form the aerodynamically advantageous profile, in particular an aerodynamic droplet shape. For this purpose, the front tube 5 is preferably held in position within the chamber 7 by appropriate longitudinal and transverse tension. Since the front tube 5 is situated within the chamber 7 and relative to the inner wall 9 thereof in a freely movable manner, the aerodynamically advantageous (droplet) profile at the leading edge 3 is continuously maintained, even when the angle of attack of the control sail 1 changes, so that the chamber 7 maintains its advantageous profile as well as its dimensional stability, even at different angles of incidence. A stable chamber 7 having a stable, preferably droplet-shaped, profile and a non-flapping lower sail 20 may be provided in this way. For this purpose, the front tube 5 is preferably situated within the chamber 7 so that it is freely movable at least in one direction which is essentially parallel to the direction of flow A incident to the leading edge 3. The chamber 7 may thus maintain a stable design, regardless of the angle of attack and the angle of incidence, so that in particular an unstable, flapping lower sail 20 may be avoided.

The transverse tube 6 may be detachably or nondetachably connected to the airfoil 2. Sewing or gluing may preferably be considered as a nondetachable connection. For a detachable connection it is conceivable, for example, for the at least one transverse tube 6 to be connected to the airfoil 2 by means of loops, straps, Velcro fasteners, zippers, snap fasteners, or the like (not illustrated).

According to one alternative embodiment, the at least one transverse tube 6, comparable to the arrangement of the front tube 5, may be accommodated, particularly preferably in a freely movable manner, in a chamber 8 which preferably extends between the leading edge 3 and the trailing edge 4 (see FIG. 1). Chamber 8 may also be referred to as the “transverse chamber” or “transverse tubetube chamber” due to its function of receiving the transverse tube 6 diposed therein.

If the control sail 1 has a chamber 7 for accommodating the front tube 5 as well as a chamber 8 for accommodating the at least one transverse tube 6, these chambers 7, 8 may be provided separately, i.e., spatially apart from one another, or may also be connected to one another. In particular for a design in which the chambers 7, 8 are connected to one another, the tube system T may be integrally formed. In this case, the tube system T is preferably initially inserted into the appropriate chambers 8 via the transverse tubes 6 and fastened with appropriate holding means, and the control sail 1 is subsequently closed around the front tube 5 in the area of the leading edge 3 in order to form the chamber 7.

The chamber 7 for accommodating the front tube 5 and/or the chamber 8 for accommodating the at least one transverse tube 6, viewed in its/their direction of longitudinal extent, may have a closed cross section at least over a portion, or over all of its/their length (see the closed cross section of the chamber 7 for accommodating the front tube 5 in FIG. 2). If the particular chamber 7, 8 has a closed cross section over its entire length, it has a one-piece design. However, it is also conceivable for the chamber to have multiple chamber sections along the leading edge 3, which in each case have a closed cross-section and which together are combined to form the corresponding chamber 7, 8. The chamber sections may be present, for example, as the result of small openings, for example at their end facing the trailing edge 4 end with respect to the front tube 5, or, viewed in the direction of longitudinal extent of the particular chamber 7, 8, may be present at least partially or completely separate from one another (the latter applies in particular for the chamber 8 of the transverse tube(s) 6).

To allow or to simplify insertion and removal, i.e., replacement, of the front tube 5 or the transverse tube 6 into and from the particular chamber 7, 8, the chamber 7, 8 in question may have at least one opening O through which the front tube 5 or the at least one transverse tube 6 is exchangeably inserted into the corresponding chamber 7, 8. The opening O may have a closable design, and may be provided, for example, by means of a material element, composed of the airfoil material, which is formed integrally with the airfoil 2 or provided separately. For this purpose, the opening O may be provided, for example, by folding the chamber 7, 8 in question over at least part or all of its length. The opening O, viewed in the longitudinal extent of the corresponding chamber 7, 8, is particularly preferably provided at at least one or both ends of the chamber 7, 8, as also illustrated in FIG. 1. The front tube 5 or the transverse tube 6 may be easily inserted into the chamber 7, 8 through these openings O, so that replacement of the tube 5, 6 in question is easily possible.

In particular to provide an aerodynamic profile of the control sail 1, the airfoil 2 is preferably tensioned over the front tube 5 and/or the at least one transverse tube 6. For this purpose, the control sail 1 preferably has a tensioning device for tensioning the airfoil 2 on the front tube 5 and/or on the least one transverse tube 6. To this end, the front tube 5 and/or the at least one transverse tube 6 in each case is/are preferably connected to the tensioning device at at least one or both of its/their opposite ends, viewed in the longitudinal extent, which preferably protrude from the openings O. However, it is also conceivable for the tensioning device to be provided only at one end of the corresponding front tube 5 or transverse tube 6, while at the end opposite from the tensioning device, the chamber 7, 8 has no opening or has a closable opening O, i.e., is closed or closable, so that, in addition to the tensioning device at one end, the front tube 5 or transverse tube 6 is also supported on the closed chamber opening O at the other end. It is also conceivable that the control sail 1, in addition to the tensioning devices which are connected to both ends or one end of the corresponding front tube 5 or transverse tube 6, has further tensioning devices for also connecting the corresponding front tube 5 or transverse tube 6 between these two end points.

The tensioning device is preferably designed as an (elastic) strap system which is preferably connected to the airfoil 2 and selectively settable in a stepped or stepless manner.

The chamber 7 for accommodating the front tube 5 and/or the chamber 8 for accommodating the at least one transverse tube 6 may be formed, at least in part, from a mesh-like or net-like material, or the material may have a corresponding mesh-like or net-like structure. In particular, the front tube 5 preferably has, preferably only in partial areas, a corresponding mesh-like or net-like structure on the bottom side of the chamber 7, i.e., on the lower sail 20. Either an opening in the chamber 7, 8 or the mentioned mesh-like or net-like structure thereof preferably ensures reliable drainage of water which penetrates into the chamber 7, 8 in question.

The present invention further relates to a kite K as illustrated in FIG. 1, for example. The kite has a control sail 1 according to the invention as well as control lines S1, S2, and preferably also safety lines, which in each case are connected to the control sail 1 at the locations correspondingly provided for this purpose. A so-called kite bar B (only schematically illustrated) which connects the kite rider to the kite K is mountable at the ends of the control lines and safety lines facing away from the control sail 1.

A method for providing a control sail 1 or kite K according to the invention is described below.

A front tube 5 is situated in a freely movable manner in a chamber 7 which extends along a leading edge 3 of an airfoil 2, in which the front tube is inserted into the chamber, for example through lateral openings O in the chamber 7. The openings O in question are then closed, or the front tube 5 is tensioned to the airfoil 2 by means of some other tensioning device. In a further step, at least one transverse tube 6 is provided on the airfoil 2 in such a way that the transverse tube extends between the leading edge 3 and a trailing edge 4 which includes the airfoil 2 together with the leading edge 3.

The present invention is not limited to the above-mentioned exemplary embodiment, provided that it is encompassed by the subject matter of the appended claims. In particular, the invention is not limited to specific materials or sail surfaces.

What I claim is:

1. A control sail for a kite comprising:
an airfoil having a leading edge and a trailing edge;
a tube system including a front tube which extends along said leading edge, and at least one transverse tube which extends between said leading edge and said trailing edge;
wherein said front tube is movably disposed within a front chamber which extends along said leading edge.

2. A control sail for a kite according to claim 1, wherein said front tube is situated within said front chamber so that it is freely movable at least in a direction transverse to the longitudinal extent of the chamber at least in a direction that is essentially parallel to the direction of flow incident to said leading edge.

3. A control sail for a kite according to claim 1, wherein said front chamber is integrally formed with said airfoil.

4. A control said for a kite according to claim 1, wherein said front chamber is separately formed and fastened to the airfoil along said leading edge.

5. A control sail for a kite according to claim 1, wherein said front chamber forms a droplet-shaped profile which tapers from the leading edge toward the trailing edge, at least when the airfoil is stretched out.

6. A control sail for a kite according to claim 1, wherein said front chamber has a closed cross section over at least over a portion thereof when viewed in its direction of longitudinal extent.

7. A control sail for a kite according to claim 1, further including at least one transverse tube connected to said airfoil.

8. A control sail for a kite according to claim 7, wherein said front tube and said at least one transverse tube are each dimensionally stable bodies.

9. A control sail for a kite according to claim 8, wherein said dimensionally stable bodies are inflatable bodies.

10. A control sail for a kite according to claim 8, wherein said dimensionally stable bodies are foam bodies.

11. A control sail for a kite according to claim 7, wherein each of said at least one transverse tubes is accommodated in a freely movable manner in a corresponding transverse chamber which extends between said leading edge and said trailing edge.

12. A control sail for a kite according to claim 11, wherein said front chamber and said transverse chamber are connected to one another.

13. A control sail for a kite according to claim 11, wherein said front chamber and said at least one transverse chamber each include at least one opening through which said front tube and said at least one transverse tube are exchangeably insertable.

14. A control sail for a kite according to claim 11, wherein said front chamber and said transverse chamber are formed, at least in part, from a mesh-like material.

15. A control sail for a kite according to claim 7, wherein said airfoil forms an aerodynamic profile by tensioning the airfoil over said front tube and over said at least one transverse tube.

16. A control sail for a kite according to claim 15, further including a tensioning device connected to said front tube and said at least one transverse tube for tensioning said airfoil relative on the front tube and the at least one transverse tube.

17. A control sail for a kite according to claim 1, further including control lines connected to said airfoil.
